(19) United States
(12) Patent Application Publication
(10) Pub. No.: US 2025/0190921 A1
(43) Pub. Date: Jun. 12, 2025

(54) RESPONSE QUALITY EVALUATION DEVICE, RESPONSE QUALITY EVALUATION METHOD, AND PROGRAM

(71) Applicant: NTT TechnoCross Corporation, Tokyo (JP)

(72) Inventors: Kazuhira MATSUI, Tokyo (JP); Shohei TAKAKURA, Tokyo (JP); Kazushi IKEDA, Tokyo (JP); Asato TANAKA, Tokyo (JP); Natsuki TADANO, Tokyo (JP); Toshihiko TANAKA, Tokyo (JP); Yoshio INOUCHI, Tokyo (JP)

(73) Assignee: NTT TechnoCross Corporation, Tokyo (JP)

(21) Appl. No.: 18/847,177

(22) PCT Filed: Mar. 18, 2022
(86) PCT No.: PCT/JP2022/012921

§ 371 Date: Sep. 13, 2024

(51) Int. Cl. G06Q 10/0639; G10L 25/51

(52) U.S. Cl. CPC G06Q 10/06395; G10L 25/51

(57) ABSTRACT

A response quality evaluation device according to one embodiment is a response quality evaluation device configured to evaluate response quality related to sales activities. The response quality evaluation device includes: a calculation unit configured to calculate an index value related to the response quality in accordance with data related to a dialogue between a person in charge of the sales activities and a customer; and a display control unit configured to display the index value on a terminal in response to a request from the terminal that is connected to the response quality evaluation device via a communication network.

### TECHNICAL FIELD

The present invention relates to a response quality evaluation device, a response quality evaluation method, and a program.

### BACKGROUND ART

In recent years, a sales technique called inside sales, in which sales activities are conducted in a non-face-to-face manner while utilizing mails, telephones, video meetings, and the like, has attracted attention. Because the inside sales are non-face-to-face sales activities, it is known as a typical issue that it is challenging to build a relationship of trust with customers compared to conventional field sales. In particular, this issue is significant when a telephone is used as a communication tool with customers.

In order to build a relationship of trust with a customer by telephone, improvement in response quality during a call is one of the important factors. Therefore, the response quality is evaluated, for example, through quantitative evaluation, such as evaluation of the length of a call duration, qualitative evaluation, such as evaluation of whether or not a randomly sampled call satisfies predetermined evaluation items, or quantitative and qualitative evaluation by combining them together.

As a related technique, a technique of evaluating the response quality of operators at a contact center is disclosed (e.g., Patent Document 1).

### RELATED ART DOCUMENTS

### Patent Documents

Patent Document 1: Japanese Laid-Open Patent Application No. 2021-44735

### SUMMARY OF THE INVENTION

### Problem to Be Solved by the Invention

However, it has not been possible to sufficiently evaluate the response quality of calls for sales activities. This is because, for example, call duration information for quantitative evaluation cannot be sufficiently obtained, or comprehensive qualitative evaluation cannot be performed by random sampling. Meanwhile, for example, when a sufficient number of pieces of call duration information are collected or the number of samples for qualitative evaluation is increased, the costs for evaluation (expense and time) increase. In particular, for qualitative evaluation, there may be cases in which a hearing is conducted with salespersons and the contents of calls are transcribed. The increase in the number of samples directly leads to an increase in the costs.

An object of one embodiment of the present invention is to evaluate the response quality related to sales activities.

### Means for Solving Problem

In order to achieve the above object, a response quality evaluation device according to one embodiment is a response quality evaluation device configured to evaluate response quality related to sales activities. The response quality evaluation device includes: a calculation unit configured to calculate an index value related to the response quality in accordance with data related to a dialogue between a person in charge of the sales activities and a customer; and a display control unit configured to display the index value on a terminal in response to a request from the terminal that is connected to the response quality evaluation device via a communication network.

### Advantageous Effects of the Invention

The response quality related to sales activities can be evaluated.

### BRIEF DESCRIPTION OF THE DRAWINGS

FIG. 1 is a diagram illustrating one example of the entire configuration of a system including a response quality evaluation device according to the present embodiment.

FIG. 2 is a diagram illustrating one example of a functional configuration of the response quality evaluation device according to the present embodiment.

FIG. 3 is a diagram illustrating one example of call data stored in a call DB.

FIG. 4 is a flowchart illustrating one example of a quality index value calculation process according to the present embodiment.

FIG. 5 is a flowchart illustrating one example of a display process of an evaluation result screen according to the present embodiment.

FIG. 6 is a diagram illustrating one example of the evaluation result screen.

FIG. 7 is a diagram illustrating a modified example of the evaluation result screen (part 1).

FIG. 8 is a diagram illustrating a modified example of the evaluation result screen (part 2).

### EMBODIMENTS FOR CARRYING OUT THE INVENTION

One embodiment of the present invention will be described below. The present embodiment relates to a response quality evaluation device 10 that is intended for a case of conducting sales activities by inside sales mainly using a telephone as a communication tool with a customer, and can evaluate response quality related to the sales activities. However, the communication tool with the customer is not limited to a telephone, and a communication tool, such as an e-mail or the like, may be used together with an e-mail. Also, the present embodiment is similarly applicable to a case in which a communication tool, such as a video call, a text chat (including those that can send and receive stamps, attachments, and the like in addition to texts) is used instead of a telephone.

### Entire Configuration

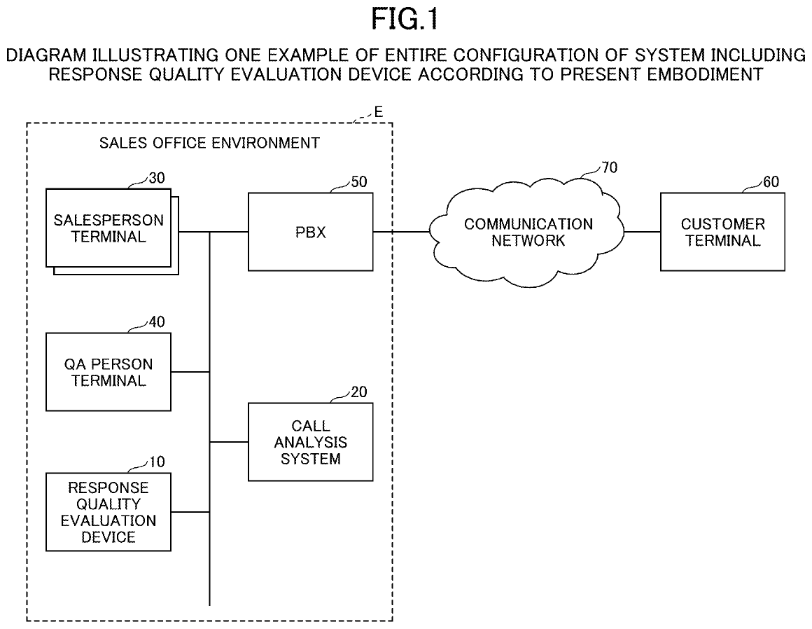

FIG. 1 illustrates the entire configuration of a system including the response quality evaluation device 10 according to the present embodiment. As illustrated in FIG. 1, this system includes the response quality evaluation device 10, a call analysis system 20, a salesperson terminal 30, a QA person terminal 40, a PBX (Private branch exchange) 50, and a customer terminal 60. Here, the response quality evaluation device 10, the call analysis system 20, the salesperson terminal 30, the QA person terminal 40, and the PBX 50 are installed in a sales office environment E, which is a system environment of a sales office in which sales activities are performed by inside sales mainly using a telephone. The sales office environment E is not limited to a system environment in the same building, but may be, for example, system environments in a plurality of geographically separated buildings.

The response quality evaluation device 10 uses data representing a result obtained by analyzing a call between a customer and a salesperson by the call analysis system 20 (hereinafter the data is also referred to as call data), thereby evaluating the response quality related to the sales activities of the salesperson and calculating various evaluation index values (hereinafter also referred to as quality index values). Here, the call data refers to data including, for example: a call ID for identifying the call of interest; a salesperson ID for identifying a salesperson who responded to the call; an utterance content representing a result obtained by converting voices during the call into texts by means of voice recognition; and a call duration of the call; speaking speeds of a customer and a salesperson; and utterance percentages of a customer and a salesperson.

The call analysis system 20 is configured to analyze a call between a customer and a salesperson by an existing analysis technique (e.g., voice recognition, speaking speed estimation, or the like), thereby generating call data. Also, the call analysis system 20 transmits the generated call data to the response quality evaluation device 10.

The salesperson terminal 30 is various terminals, such as, for example, a PC (personal computer) used by a salesperson in charge of sales activities for customers, and functions as an IP (Internet Protocol) telephone set.

The QA person terminal 40 is various terminals, such as, for example, a PC used by a QA (Quality Assurance) person who assures response quality related to sales activities.

The PBX 50 is a telephone exchange (IP-PBX) and is connected to a communication network 70 including a VOIP (Voice over Internet Protocol) network and a PSTN (Public Switched Telephone Network).

The customer terminal 60 is various terminals, such as a smartphone, a mobile phone, a fixed telephone, and the like that are used by a customer.

The entire configuration of the system illustrated in FIG. 1 is merely illustrative, and other configurations may be possible. For example, in the example illustrated in FIG. 1, the response quality evaluation device 10 is included in the sales office environment E (i.e., the response quality evaluation device 10 is of an on-premise type). However, all or a part of the functions of the response quality evaluation device 10 may be realized by a cloud service or the like. Similarly, in the example illustrated in FIG. 1, the call analysis system 20 is of an on-premise type. However, all or a part of the functions of the call analysis system 20 may be realized by a cloud service or the like. Similarly, in the example illustrated in FIG. 1, the PBX 50 is a telephone exchange of an on-premise type, but may be realized by a cloud service or the like.

Although the salesperson terminal 30 also functions as an IP telephone set, for example, a telephone set may be installed in the sales office environment E separately from the salesperson terminal 30.

### Functional Configuration

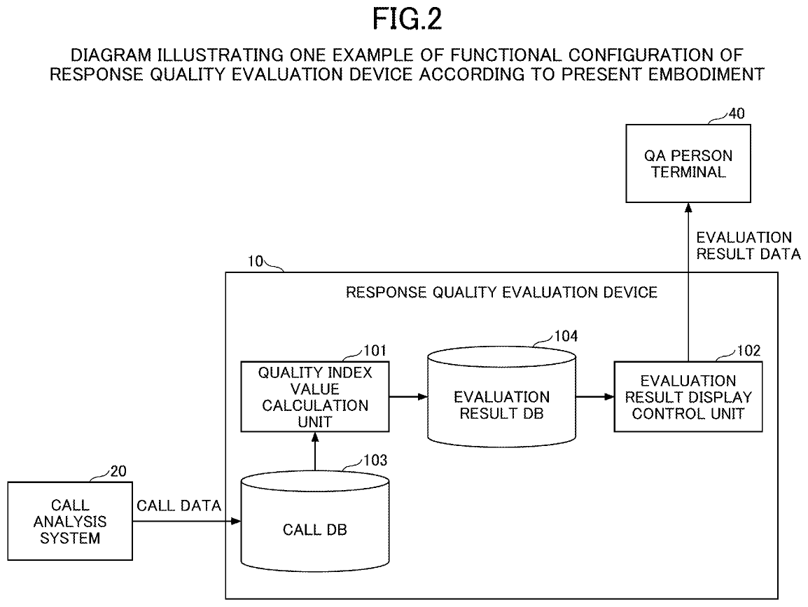

FIG. 2 illustrates the functional configuration of the response quality evaluation device 10 according to the present embodiment. As illustrated in FIG. 2, the response quality evaluation device 10 according to the present embodiment includes a quality index value calculation unit 101 and an evaluation result display control unit 102. Each of these units is realized, for example, through a process performed by a processor, such as a CPU (Central Processing Unit) or the like, that is executed in accordance with one or more programs installed in the response quality evaluation device 10. Also, the response quality evaluation device 10 according to the present embodiment includes a call DB 103 and an evaluation result DB 104. Each of these DBs (databases) is realized, for example, by a storage device, such as an HDD (Hard Disk Drive), an SSD (Solid State Drive), a flash memory, or the like.

The quality index value calculation unit 101 is configured to use the call data stored in the call DB 103, thereby evaluating the response quality related to the sales activities of the salesperson during a predetermined period (hereinafter also referred to as an evaluation period) and calculating the quality index values. Also, the quality index value calculation unit 101 stores the calculated quality index values, as evaluation result data, in the evaluation result DB 104 for respective periods and for respective salespersons. Here, in the present embodiment, five quality index values, i.e., open-heart capability, empathy capability, pace capability, dialogue capability, and commitment capability, are introduced as the quality index values. In the following, these five quality index values can each take a value of 0 or higher and 100 or lower. A specific calculation method for these five quality index values will be described below.

The open-heart capability is a quality index that indicates whether or not a personal topic could be mentioned in a call with a customer and whether or not the call duration was long. This is because it is conceivable that when a personal topic is mentioned and the call duration is long to some extent, the customer is open to the salesperson.

The empathy capability is a quality index that indicates whether or not the call duration was long. This is because it is conceivable that the longer the call duration, the more the customer is open.

The pace capability is a quality index that indicates whether or not the customer could speak at a speaking speed according to the speaking speed of the customer. This is because it is conceivable that speaking at a pace that is close to that of the customer leads to the formation of the customer's sense of security.

The dialogue capability is a quality index that indicates whether or not the customer made many utterances. This is because it is conceivable that the higher the percentage of utterances made by the customer compared to the salesperson, the more the customer is interested in the sales target product or service.

The commitment capability is a quality index that indicates whether or not some agreement (commitment) is made with the customer, such as, for example, whether or not a material related to the sales target product or service could be sent to the customer, and whether or not some promise could be made. This is because it is conceivable that when the salesperson could send the customer a material related to the sales target product or service or could make some promise (e.g., an appointment to make the next phone call, or the like), an agreement (commitment) was made with the customer, leading to the next sales activities.

In response to a request from the QA person terminal 40, the evaluation result display control unit 102 transmits evaluation result data corresponding to the request among the evaluation result data stored in the evaluation result DB 104. In accordance with the evaluation result data, the display of the QA person terminal 40 displays a screen including a salesperson ID, a salesperson name, an evaluation period, quality index values of the salesperson during the evaluation period, and the like (hereinafter this screen is also referred to as an evaluation result screen).

The call DB 103 stores the call data received from the call analysis system 20.

The evaluation result DB 104 stores evaluation result data.

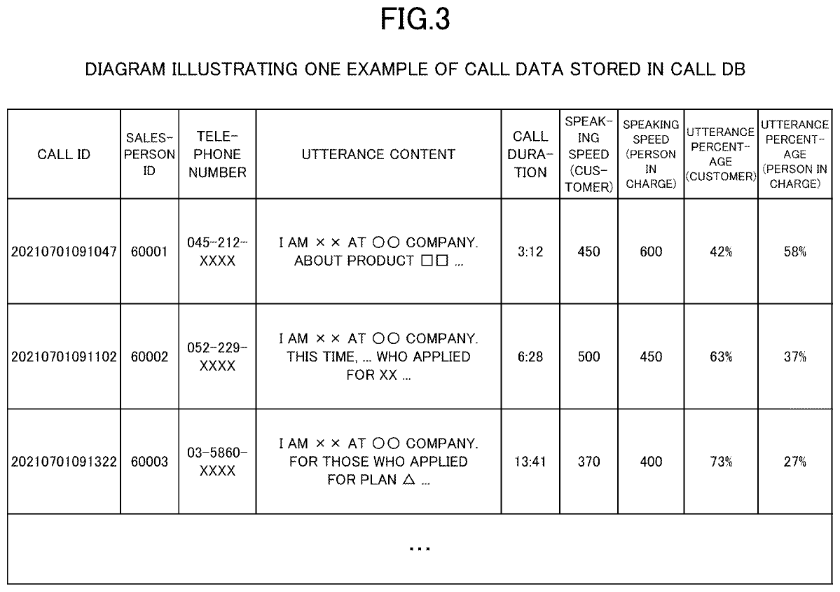

FIG. 3 illustrates one example of the call data stored in the call DB 103. As illustrated in FIG. 3, one or more call data are stored in the call DB 103, and the call data includes a call ID, a salesperson ID, a telephone number, an utterance content, a call duration, a speaking speed (customer), a speaking speed (person in charge), an utterance percentage (customer), and an utterance percentage (person in charge).

The call ID is identification information for identifying the call. The salesperson ID is identification information for identifying the salesperson who responded to the call. The telephone number is a telephone number of the customer in the call. The utterance content is a text representing the result obtained by processing voices during the call through voice recognition by a voice recognition technique. The call duration is a duration of from the beginning of the call to the end of the call. The speaking speed (customer) is a speaking speed of the customer in the call (or an average thereof). The speaking speed (person in charge) is a speaking speed of the salesperson in the call (or an average thereof). The utterance percentage (customer) is a percentage of utterances made by the customer in the call. The utterance percentage (person in charge) is a percentage of utterances made by the salesperson in the call.

The call data illustrated in FIG. 3 is merely illustrative, and various information other than the above may be included in the call data. For example, information representing the result obtained by analyzing the emotion of the customer by an existing emotion analysis technique may be included in the call data.

### Quality index Value Calculation Process

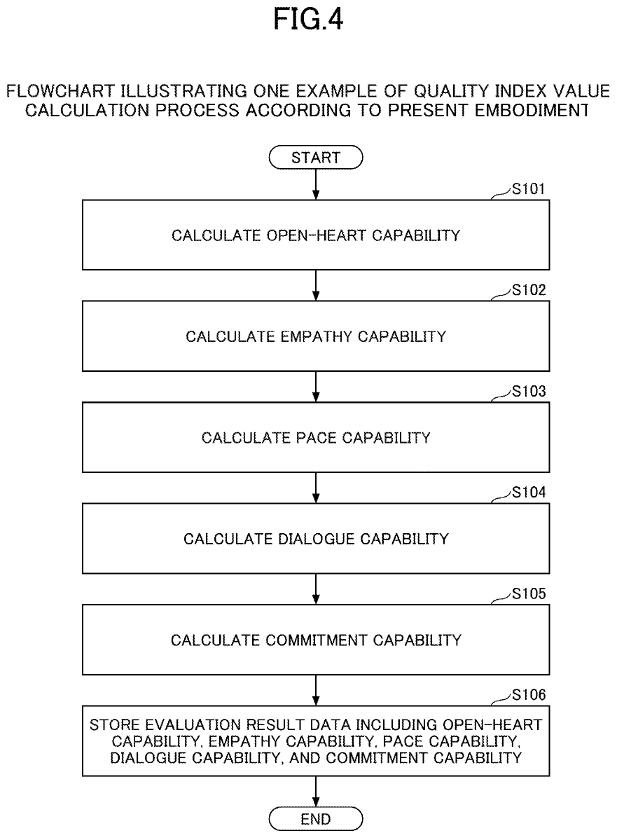

In the following, a quality index value calculation process in a case of evaluating the response quality of a predetermined salesperson during a predetermined evaluation period and calculating the quality index values will be described with reference to FIG. 4. The quality index value calculation process is performed repeatedly for respective evaluation periods and for respective salespersons. The evaluation period may be set to a desired period. However, for example, it is conceivable that the evaluation period is set to one day, one week, one month, one quarter, one year, or the like. Steps S101 to S105 below may be performed in a desired order, or may be performed in parallel.

In the following, the call data stored in the call DB 103 is denoted by Dᵢ, and the number N of call data Dᵢ are stored in the call DB 103. That is, a set of the call data stored in the call DB 103 is D={Dᵢ|i=1, . . . , N}. Also, the set of the call data of the salesperson during the evaluation period is D′={Dᵢ|i∈E}. E is an index set of the call data of the salesperson during the evaluation period, and |E|=M (<N) is satisfied.

The quality index value calculation unit 101 uses the call data stored in the call DB 103, thereby calculating the open-heart capability of the salesperson during the evaluation period (step S101). Here, the quality index value calculation unit 101 calculates the open-heart capability of the salesperson during the evaluation period in accordance with (1-1) to (1-3) below. In the following, the average of the call duration of the call data Dᵢ∈D is denoted by μ₁, and the standard deviation thereof is denoted by σ₁.
(1-1) For the call data Dᵢ∈D′, it is determined whether or not the utterance content of the call data Dᵢ∈D′ includes a specific word set describing a personal topic. In the following, the index set of the call data Dᵢ∈D′ in which a specific word set describing a personal topic is included in the utterance content is E₁₁⊂E. The specific word set describing a personal topic is a set of words or keywords describing a personal topic, and is expressed as {w₁ᵢ |w₁ᵢ is a word or keyword describing a personal topic}. The word or keyword describing a personal topic may be, for example, a word or keyword describing a typical hobby or interest, a word or keyword describing current affairs, or the like.

However, this is by no means a limitation. For example, for each of the customers, the word or keyword describing a personal topic may be a word or keyword describing the customer's personal hobby or interest, a word or keyword describing the customer's personal topic, or the like. Such a word or keyword describing the customer's personal topic for respective customers may be created or extracted from information (e.g., customer's contract information and the like) registered in a customer management system, such as CRM (Customer Relationship Management) or the like.
(1-2) For the call data Dᵢ∈D′, it is determined whether or not the call duration of the call data Dᵢ∈D′ is equal to or longer than μ₁+σ₁. In the following, the index set of the call data Dᵢ∈D′ in which the call duration is equal to or longer than μ₁+σ₁ is E₁₂⊂E.
(1-3) Then, a percentage of the call data Dᵢ∈D′ in which the utterance content includes a specific word set describing a personal topic and the call duration is equal to or longer than μ₁+σ₁ is calculated as the open-heart capability. That is, (|E₁₁∩E₁₂|/M) ×100 [%] is calculated as the open-heart capability. Therefore, the open-heart capability can be described as “percentage of calls, in the calls, that include a word describing the customer themselves and are equal to or longer than a predetermined length of time”.

The quality index value calculation unit 101 uses the call data stored in the call DB 103, thereby calculating the empathy capability of the salesperson during the evaluation period (step S102). Here, the quality index value calculation unit 101 calculates the empathy capability of the salesperson during the evaluation period in accordance with (2-1) to (2-3) below.
(2-1) A lower-limit call duration b₁ is μ₁ and an upper-limit call duration a₁ is μ₁+2σ₁, and a score is defined as follows. Specifically, the score is 0 when the call duration is less than the lower-limit call duration b₁. The score is a linear score when the call duration is the lower-limit call duration b₁ or more and the upper-limit call duration a₁ or less. The score is 100 when the call duration is more than the upper-limit call duration a₁. Here, the linear score means a score that is 0 when the call duration is b₁ and is 100 when the call duration is a₁, and the value of the score linearly changes between b₁ and a₁. Specifically, when x is a call duration and y is a score, the score is expressed by y=(100/(a₁−b₁)) (x−b₁).
(2-2) For the call data Dᵢ∈D′, the score (score defined in the above (2-1)) is calculated from the call duration of the call data Dᵢ∈D′.
(2-3) Then, the average [%] of the scores of the call data Dᵢ∈D′ is calculated as the empathy capability. Therefore, the empathy capability can be described as “average (score) of the relative values of the call durations of the calls of interest with respect to the call duration distribution of the calls”.

The quality index value calculation unit 101 uses the call data stored in the call DB 103, thereby calculating the pace capability of the salesperson during the evaluation period (step S103). Here, the quality index value calculation unit 101 calculates the pace capability of the salesperson during the evaluation period in accordance with (3-1) to (3-4) below. In the following, the average of the speaking speed (customer) of the call data Dᵢ∈D is μ₂ and the standard deviation thereof is σ₂, and the average of the speaking speed (person in charge) of the call data Dᵢ∈D is μ₃ and the standard deviation thereof is σ₃.
(3-1) For the call data Dᵢ∈D′, the coefficient kᵢ=dᵢ /μ₂ is calculated, where dᵢ is the speaking speed (customer) of the call data Dᵢ∈D′.
(3-2) For the call data Dᵢ∈D′, the recommended speaking speed vᵢ=kᵢ×μ₃ of the call data Dᵢ∈D′ is calculated.
(3-3) For the call data Dᵢ∈D′, the speaking speed (person in charge) of the call data Dᵢ∈D′ is denoted by eᵢ, and it is determined whether or not the following conditions are satisfied.
In the case in which kᵢ≥1 (i.e., when the customer's speaking speed is normal or fast),
eᵢ is within the range of μ₃±20 [mora/minute] (i.e., the salesperson's speaking speed is an average speed).
In the case in which kᵢ<1 and vᵢ≥μ₂−2σ₂ (i.e., when the customer speaks somewhat slowly),
eᵢ is within the range of vᵢ±20 [mora/minute] (i.e., the salesperson's speaking speed is approximately the recommended speaking speed).
In the case in which kᵢ<1 and vᵢ<μ₂−2σ₂ (i.e. the customer speaks slowly),
eᵢ is within the range of μ₂−2σ₂±20 [mora/minute] (i.e., the salesperson speaks slowly, too).

In the following, the index set of the call data Dᵢ∈D′ satisfying the above conditions is defined as E₂⊂CE.

The above conditions each include ±20 [mora/minute], which is, however, merely illustrative and by no means a limitation. For example, this can be appropriately changed to ±25 [mora/minute], ±15 [mora/minute], or the like.
(3-4) Then, the percentage of the call data Dᵢ∈D′ satisfying the above condition is calculated as the pace capability. That is, (|E₂|/M)×100 [%] is calculated as the pace capability. Therefore, the pace capability can be described as “percentage of calls in which the salesperson spoke at a speaking speed according to the speaking speed of the customer”.

The quality index value calculation unit 101 uses the call data stored in the call DB 103, thereby calculating the dialogue capability of the salesperson during the evaluation period (step S104). Here, the quality index value calculation unit 101 calculates the dialogue capability of the salesperson during the evaluation period in accordance with (4-1) to (4-3) below. In the following, the average of the utterance percentage (customer) of the call data Dᵢ∈D is μ₄ and the standard deviation thereof is σ₄.
(4-1) A lower-limit utterance percentage b₂ is μ₄ and an upper-limit utterance percentage a₂ is μ₄+2σ₄, and a score is defined as follows. Specifically, the score is 0 when the utterance percentage is less than the lower-limit utterance percentage b₂. The score is a linear score when the utterance percentage is the lower-limit utterance percentage b₂ or more and the upper-limit utterance percentage a₂ or less. The score is 100 when the utterance percentage is more than the upper-limit utterance percentage a₂. Here, the linear score means a score that is 0 when the utterance percentage is b₂ and is 100 when the utterance percentage is a₂, and the value of the score linearly changes between b₂ and a₂. Specifically, when x is an utterance percentage and y is a score, the score is expressed by y=(100/(a₂−b₂)) (x−b₂).
(4-2) For the call data Dᵢ∈D′, the score (score defined in the above (4-1)) is calculated from the utterance percentage (customer) of the call data Dᵢ∈D′.
(4-3) Then, the average [%] of the scores of the call data Dᵢ∈D′ is calculated as the dialogue capability. Therefore, the dialogue capability can be described as “average (score) of the relative values of utterance percentages of the customers in the calls of interest with respect to the utterance percentage distribution of the customer in the calls”.

The quality index value calculation unit 101 uses the call data stored in the call DB 103, thereby calculating the commitment capability of the salesperson during the evaluation period (step S105). Here, the quality index value calculation unit 101 calculates the commitment capability of the salesperson during the evaluation period in accordance with (5-1) to (5-3) below.
(5-1) For the call data Dᵢ∈D′, it is determined whether or not the utterance content of the call data Dᵢ∈D′ includes a specific word set describing an agreement (commitment) with the customer. Here, the agreement (commitment) with the customer means an agreement, such as sending a mail or material, a promise for the next business meeting, a promise with the customer, or the like. In the following, the index set of the call data Dᵢ∈D′ including a specific word set describing sending a mail or material in the utterance content is E₃₁⊂E. Here, the specific word set describing sending a mail or material is a set of words or keywords used when sending a mail or material, and is expressed as {w₂ᵢ|w₂ᵢ is a word or keyword used when sending a mail or material}. The word or keyword used when sending a mail or material is, for example, a word or keyword, such as “I sent you a material”, “mail address”, or the like.
(5-2) For the call data Dᵢ∈D′, it is determined whether or not the utterance content of the call data Dᵢ∈D′ includes a specific word set describing a promise. In the following, the index set of the call data Dᵢ∈D′ in which the utterance content includes the specific word set describing a promise is E₃₂⊂E. Here, the specific word set describing a promise is a set of words or keywords used when making a promise with the customer, and is expressed as {w₃ᵢ|w₃ᵢ is a word or keyword used when making a promise}. The word or keyword used when making a promise is, for example, a word or keyword, such as “I make a promise”, “I can help you”, or the like.
(5-3) Then, a percentage of the call data Dᵢ∈D′ in which the utterance content includes a specific word set describing sending a mail or material and a specific word set describing making a promise is calculated as the commitment capability. That is, (E₃₁∩E₃₂|/M)×100 [%] is calculated as the commitment capability. Therefore, the commitment capability can be described as “percentage of calls, in the calls, that include utterances describing an agreement (commitment) with the customer”.

Finally, the quality index value calculation unit 101 stores, in the evaluation result DB 104: the salesperson ID of the salesperson; the evaluation period; and the evaluation result data including the open-heart capability, the empathy capability, the pace capability, the dialogue capability, and the commitment capability calculated in steps S101 to S105 (step S106).

### Display Process of the Evaluation Result Screen

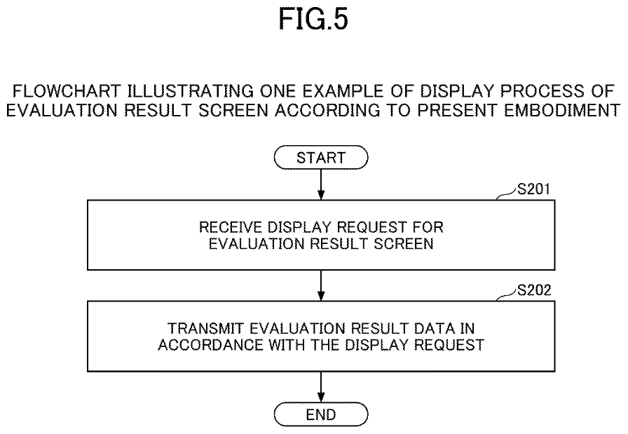

In the following, the display process of the evaluation result screen in a case of displaying, on a display of the QA person terminal 40, the evaluation result screen including the quality evaluation values of a predetermined salesperson during a predetermined evaluation period will be described with reference to FIG. 5. The following will be described assuming that a request designating at least the salesperson ID and the evaluation period (a display request for the evaluation result screen) is transmitted from the QA person terminal 40 to the response quality evaluation device 10.

The evaluation result display control unit 102 receives the display request for the evaluation result screen from the QA person terminal 40 (step S201).

The evaluation result display control unit 102 obtains, from the evaluation result DB 104, evaluation result data including the salesperson ID and the evaluation period designated in the display request, and transmits the obtained evaluation result data to the QA person terminal 40 (step S202). Thereby, an evaluation result screen as described below is displayed on the display of the QA person terminal 40 in accordance with the evaluation result data.

### Evaluation Result Screen

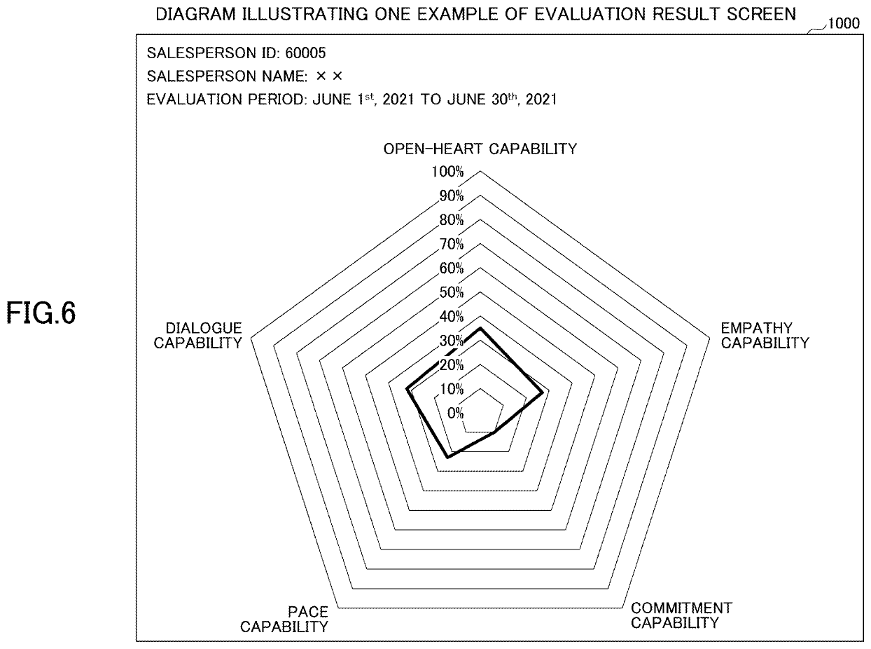

FIG. 6 illustrates one example of the evaluation result screen displayed on the display of the QA person terminal 40. An evaluation result screen 1000 illustrated in FIG. 6 is a screen that displays, as a radar chart, the quality index values included in the evaluation result data received from the response quality evaluation device 10. Thereby, the QA person can confirm the quality index values of a predetermined salesperson during a predetermined evaluation period (in the example illustrated in FIG. 6, the evaluation index values of the salesperson ID “60005” and the salesperson name “xx” during the evaluation period “Jun. 1, 2021 to Jun. 30, 2021”). Therefore, the QA person can consider, for example, various measures for improving the response quality for the customers with reference to the evaluation result screen 1000.

### MODIFIED EXAMPLES

Hereinafter, modified examples of the present embodiment will be described.

### Modified Example 1

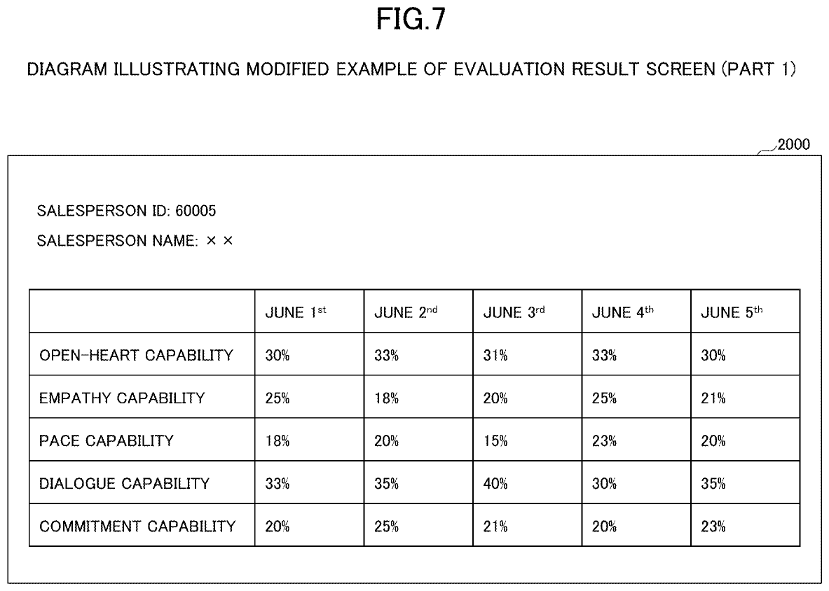

A plurality of evaluation periods may be designated in the display request for the evaluation result screen. In this case, the quality index values of the salesperson in the plurality of evaluation periods may be displayed so as to be able to be compared. As one example, FIG. 7 illustrates an evaluation result screen in a case in which the evaluation period is one day and the period of from “June 1^{st}” to “June 5^{th}” is designated in the display request. On an evaluation result screen 2000 illustrated in FIG. 7, the quality index values of the salesperson during respective evaluation periods of from “June 1^{st}” to “June 5^{th}” (salesperson ID “60005” and salesperson name “xx”) are displayed so as to be able to be compared. Thereby, the QA person can compare the quality index values of the salesperson between the evaluation periods.

In the example illustrated in FIG. 7, respective evaluation periods are one day, but respective evaluation periods can be a given period (e.g., one week, one month, one quarter, one year, or the like).

### Modified Example 2

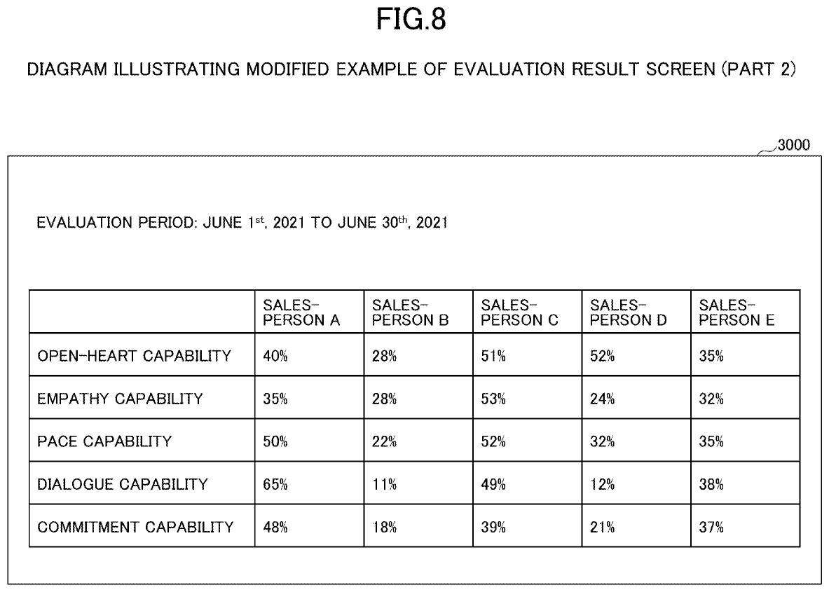

A plurality of salesperson IDs may be designated in the display request for the evaluation result screen. In this case, the quality index values of the plurality of salespersons during the evaluation period may be displayed so as to be able to be compared. As one example, FIG. 8 illustrates an evaluation result screen in a case in which the salesperson IDs of “salesperson A” to “salesperson E” are designated in the display request. On an evaluation result screen 3000 illustrated in FIG. 8, the quality index values of “salesperson A” to “salesperson E” during the evaluation period of “Jun. 1, 2021 to Jun. 30, 2021” are displayed so as to be able to be compared. Thereby, the QA person can compare the quality index values of the plurality of salespersons during a predetermined evaluation period.

### Modified Example 3

When calculating the open-heart capability, it is determined in the above (1-1) whether or not the utterance content includes a specific word set describing a personal topic. At this time, by using different word sets, the open-heart capability corresponding to respective word sets may be calculated.

For example, when there are a word set A describing a personal topic, a word set B describing a personal topic, and a word set C describing a personal topic, the open-heart capability corresponding to the word set A, the open-heart capability corresponding to the word set B, and the open-heart capability corresponding to the word set C may be calculated by performing the determination in the above (1-1) for respective word sets.

Similarly, when calculating the commitment capability, a plurality of specific word sets describing sending a material may be used, or a plurality of specific word sets describing commitment may be used.

### Conclusion

As described above, the response quality evaluation device 10 according to the present embodiment is intended for inside sales mainly using a telephone as a communication tool, and can calculate various index values obtained by evaluating a service quality of a salesperson during a predetermined evaluation period. These index values quantitatively represent important factors for building a relationship of trust with customers and leading to, for example, sales of goods or services. Thus, sales activities can be conducted more effectively by improving these index values. In addition, the QA person can consider various measures for improving these index values (e.g., education of salespersons, and the like).

In the present embodiment, the five quality index values, i.e., the open-heart capability, the empathy capability, the pace capability, the dialogue capability, and the commitment capability are calculated. However, the five quality index values need not necessarily be calculated, and only some of the quality index values may be calculated if necessary. Also, existing quality index values other than these five quality index values may be calculated.

The present invention is not limited to the embodiments specifically disclosed above. Various modifications or changes, combinations with existing techniques, and the like are possible without departing from the scope of the claims as recited.

### REFERENCE SIGNS LIST

10 Response quality evaluation device
20 Call analysis system
30 Salesperson terminal
40 QA person terminal
50 PBX
60 Customer terminal
70 Communication network
101 Quality index value calculation unit
102 Evaluation result display control unit
103 Call DB
104 Evaluation result DB
E Sales office environment

1. A response quality evaluation device configured to evaluate response quality of a sales task, the response quality evaluation device comprising:
a memory; and
at least one processor connected to the memory, wherein
the processor is configured to;
calculate an index value of the response quality in accordance with data of a dialogue between a first person and a second person; and
display the index value on a terminal in response to a request from the terminal that is connected to the response quality evaluation device via a communication network.

2. The response quality evaluation device according to claim 1, wherein
the index value calculated by the processor is an open-heart capability that represents a percentage of a first set of dialogues between the first person and the second person, among a plurality of dialogues between the first person and the second person, the first set of dialogues includes a word describing the customer, and time durations of respective dialogues of the first set of dialogues are at least a predetermined length of time.

3. The response quality evaluation device according to claim 1, wherein
the first person represents a person in charge,
the second person represents a customer, and
the data of the dialogue comprises at least one of:
a duration of from a beginning to an end of the dialogue;
a speaking speed of the customer;
a speaking speed of the person in charge;
an utterance percentage of the customer; or
an utterance percentage of the person in charge.

4. The response quality evaluation device according to claim 1, wherein
the first person performs the sales task,
the second person represents a customer, and
the sales task comprises an inside sales task using a telephone, a mail, a video call, or a text chat as a communication tool with the customer.

5. The response quality evaluation device according to claim 1, wherein
the processor is configured to
calculate the index value of the first person performing the sales task during one or more evaluation periods of predetermined evaluation periods of the plurality of evaluation periods.

6. The response quality evaluation device according to claim 5, wherein
the processor is configured to
display, on the terminal, the index value of the first person during the plurality of evaluation periods for comparison between the plurality of evaluation periods.

7. (canceled)

8. A response quality evaluation method, comprising:
calculating an index value of response quality in accordance with data of a dialogue between a first person and a second person; and
displaying the index value on a terminal in response to a request from the terminal that is connected to a response quality evaluation device via a communication network,
the calculating and the displaying being executed by the response quality evaluation device that is configured to evaluate the response quality of a sales task.

9. A non-transitory computer-readable recording medium storing a program that causes a response quality evaluation device configured to evaluate response quality of a sales task to execute:
calculating an index value of the response quality in accordance with data of a dialogue between a first person and a second person; and
displaying the index value on a terminal in response to a request from the terminal that is connected to the response quality evaluation device via a communication network.

10. The response quality evaluation device according to claim 1, wherein
the first person receives a call from the second person for starting the dialogue, the first person represents a salesperson performing an inbound sales task, and the second person represents a customer calling the salesperson.

11. The response quality evaluation device according to claim 8, wherein
the first person receives a call from the second person for starting the dialogue, the first person represents a salesperson performing an inbound sales task, and the second person represents a customer calling the salesperson.

12. The response quality evaluation device according to claim 9, wherein
the first person receives a call from the second person for starting the dialogue, the first person represents a salesperson performing an inbound sales task, and the second person represents a customer calling the salesperson.

13. The response quality evaluation device according to claim 5, wherein
the processor is configured to
display, on the terminal, the index value of a plurality of first persons, each being the first person, during the same evaluation period for comparison between the plurality of first persons.

14. The response quality evaluation device according to claim 1, wherein
the index value calculated by the processor is an empathy capability that represents substantially an average of respective time durations of respective dialogues of a plurality of dialogues between the first person and the second person according to a dialogue duration distribution of the plurality of dialogues.

15. The response quality evaluation device according to claim 1, wherein
the index value calculated by the processor is a pace capability that represents a percentage of dialogues between the first person and the second person in a dialogue of a plurality of dialogues, and the first person speaks at a speaking speed in the dialogue according to a speaking speed of the second person in the dialogue.

16. The response quality evaluation device according to claim 1, wherein
the index value calculated by the processor is a dialogue capability that represents substantially an average of utterance percentages of the second person in a plurality of dialogues between the first person and the second person according to an utterance percentage distribution of the second person in the plurality of dialogues.

17. The response quality evaluation device according to claim 1, wherein
the index value calculated by the processor is a commitment capability that represents a percentage of a second set of dialogues of a plurality of dialogues, among the plurality of dialogues between the first person and the second person, and the second set of dialogues includes utterances describing the first person in agreement with the second person.
